(19) United States
(12) Patent Application Publication
(10) Pub. No.: US 2023/0128760 A1
(43) Pub. Date: Apr. 27, 2023

(54) Methods and Means for Improved Benefit Selection and Enrollment

(71) Applicant: Enrollment Alliance, LLC, Tampa, FL (US)

(72) Inventors: Robert James LESSMAN, Tampa, FL (US); Jeff YARISH, Tampa, FL (US)

(73) Assignee: Enrollment Alliance, LLC, Tampa, FL (US)

(21) Appl. No.: 17/974,186

(22) Filed: Oct. 26, 2022

Related U.S. Application Data
(60) Provisional application No. 63/272,434, filed on Oct. 27, 2021.

(51) Int. Cl. G06Q 10/1057

(52) U.S. Cl. CPC G06Q 10/1057

(57) ABSTRACT

Methods and means for improving open enrollment and new hire enrollment and registration in insurance products are provided, and more specifically, methods and means for improved, more efficient methods for communicating updates regarding enrollment details and their registration in insurance products are provided.

### CROSS-REFERENCES TO RELATED APPLICATIONS

This patent application claims benefit of U.S. Provisional Patent Application No. 63/272,434 filed Oct. 27, 2021, the contents of which are hereby incorporated by reference in their entirety.

### TECHNICAL FIELD

The present invention relates generally to methods and means for improving open enrollment and new hire enrollment and registration in insurance products, and in a particular, though non-limiting embodiment to methods and means for improved, more efficient methods for communicating updates regarding enrollment details and their registration in insurance products.

### BACKGROUND AND OBJECTS OF THE INVENTION

Previously known products have attempted to efficiently tie together various aspects of enrollment communication, such as delivering benefits marketing materials, attending benefits meetings, viewing benefits videos, and delivering options for enrollment action (such as a URL to login to benefits websites).

Most companies offer individualized benefits to employees based on salaries, employee class, etc., that are all important but fundamentally different sectors of employee enrollment management. Thus, these early attempts to integrate such complex but only tangentially related sectors have proven inefficient and cumbersome due, for example, to incompatible operating or programming systems, key data delivered in different formats, etc.

There is, therefore, a long felt but unmet need for an administrative enrollment system and methods of use therefor that provides a simple, uniform method of assignment and record creation, wherein an employee at open enrollment and/or upon new employment is automatically assigned with individualized benefit characteristics that include, but are not limited to, benefit videos, marketing brochures, QR codes, waiting periods, enrollment deadlines, unique scheduling options, etc., all designed to create a personalized experience for each employee even though many of the conversations are being managed with artificial intelligence (“A”″) or other forms of machine intelligence or automation. These employees can also be easily assigned to an enrollment agent capable of managing many employees benefit meetings across various companies.

There is also a need for such methods wherein. once an enrollment process has occurred, notes and updates relating to each employee and client are updated, either automatically or manually, and immediately available for review for the human resources leader (client), broker, carrier partners, and/or other key players in the system. This process eliminates the industry's typically ambiguous communications that transpire when an insurance agent is communicating directly with thousands of employees via phone, email, text, etc.

The system disclosed herein limits the number of manual communications that typically transpire between agent and employees, which admits to greater consistency and accuracy to the messages sent and benefit-related details provided because human error is eliminated using automations and auto responses based on outcomes of benefit meetings.

There is also a need for removing alienating institutional barriers associated by clients with selection of insurance; for example, by streamlining and personalizing the user interface and information management system so that the user is better able to quickly progress through the insurance selection and acquisition process.

### DETAILED DESCRIPTION

The engine of the system from the user's perspective is a dashboard designed to solve both common and complex challenges due to lack of communication and transparency between the parties necessary to perform an enrollment for a business client.

In one example embodiment, the method begins with definition of a plurality of user type. In a further embodiment, the plurality of user types comprises one or more of the following user types, though those of skill in the art will readily appreciate that other user types could be defined, or added or deleted from the representative user types, while remaining within the scope of the present disclosure.

### Representative User Types

Insurance Carrier—Insurance carriers typically desire insight into employee engagements in order to better predict and improve participation in various product offerings.
Third Party Vendors (e.g., Payroll, COBRA Administrators, TPAs, etc.)—Third party vendors generally lack effective ways to communicate to employees both during enrollment and throughout the year.
Insurance Brokers & Agency Account Managers—Similar to insurance carriers, insurance brokers and agency account managers desire insight into employee engagement across various enrollment elements.
Human Resources—A majority of human resource departments are understaffed (especially during open enrollment).
Benefit Administration Systems—Benefit administration systems are automated technical systems that have eliminated the need for paper applications industry-wide, as well as manual data transmission from client to insurance carrier. All such systems require an employee credentials and permissions to log in and access the system, which prevents them from providing critical information to educate and inform employees prior to actually gaining access to the system.
Enrollment Entity—Enrollment firms (typically a competitor) have a for setting up enrollments, building employee profiles, and designing communication campaigns.
Benefit Counselors—Benefit counselors are primarily independent contractors that work for multiple enrollment entities throughout the year, and have a need for a streamlined approach to interaction between counselors and employees. Removing unnecessary steps, multiple systems, and manual steps typically associated with this job, creates an opportunity for enrollment entities to attract and retain better benefit counselors.
Employees—Employees of companies often experience a single-source platform that is branded as their employer which creates a more trustworthy experience than previous attempts to “communicate with employees.” Receiving timely messages written with verbiage that applies specifically to them, ability to display info unique to each person, with their employer's branding creates an experience that drastically increases participation and interaction with benefits related media and information.

According to other example embodiments, the dashboard is designed to solve for many common industry challenges, and each challenge affects user types in a different manner Users each experience a unique dashboard view, and receive unique alerts and reminders corresponding with the priorities associated with their specific industry.

In one example embodiment, the method further comprises definition of a plurality of action types. In a further embodiment, the plurality of action types comprises one or more of the following action types, though those of skill in the art will readily appreciate that other action types could be defined, or added or deleted from the representative action types, while remaining within the scope of the instant disclosure.

### Representative Action Types

In one embodiment, action types comprise one or more features including delivery and timing of messages; and responding to and from employees based on actions and/or inaction.

In another example embodiment, the action types comprise one or more features including video engagement and/or mobile app engagement.

In a further embodiment, the action types comprise one or more features including scheduling an appointment progress; phone interaction; screen share interaction; employee text interaction; and live chat interaction.

In a still further embodiment, the action types comprise one or more features including QR code clicks; URL visits; and a live chat history.

In a further embodiment still, the action types comprise one or more features including online forms and the status of enrollment completion; brochures and other informational interactions; and confirmation of employee reviewed documents.

In a still further embodiment, the action types comprise one or more features including increasing the number of employee & benefit counselor meetings; increasing the number of employees enrolled in self-service systems; and increasing the participation premium generated in insurance products.

According to another aspect of the invention, the dashboard is designed to simplify the construction and delivery of communication assets (e.g., a mobile app, etc.) with icons specific to each employee, online videos, visual marketing, etc., to employees within a company. In one embodiment, the messages and experiences are branded as the business client, which those of skill in the art will appreciate creates trust and, higher adoption of messages amongst employees within any organization. Messaging is important throughout various stages of the year and is not limited to open enrollment.

For example, during pre-enrollment, delivering timely and personalized texts, emails, videos, brochures, mobile app experiences, etc., is crucial prior to the start of an enrollment, and drives the behavior of employees and ultimately the indicator of enrollment outcomes.

During the course of the enrollment, human resources departments frequently need to direct attention to employees that either need help or have been non-responsive to attempts to start their enrollment The disclosed system automates the process, and follows up with employees throughout open enrollment with unique messaging based on their response/lack of response throughout the process.

After an open enrollment is complete (in other words, the employee's deadline to elect benefits has come to a close), human resources and brokers are still left with many manual tasks, such as providing confirmation statements to employees, collecting carrier forms (e.g., EOIs, dependent data, beneficiary details, etc.). The presently disclosed method provides a simple and automated path to communicating with such employees and removes the manual process from human resource teams and brokers.

Many companies struggle with employee behavior throughout the calendar year in regards to cost containment. In this context, the term “cost containment” refers to an industry trend that attempts to inform employees how to choose healthcare expenses in their day-to-day lives so that the company and employees insurance premium increases are minimized. The disclosed methods and systems allow brokers and business clients to build employee facing messaging and mobile app experiences throughout the year—branded as their own business, if desired—which directly correlates to the employee adoption rate of initiatives presented on healthcare objectives.

Human resources departments utilize the system to engage new employees with personalized messages and experiences that typically require time-consuming manual follow up. Since human resources departments are tasked with managing all new hire timelines, which vary depending on employee types, the system again automates emails, texts, reminders, and content to improve the new employee onboarding experience and saves human resources teams countless hours of follow up.

Those of skill in the art will also appreciate that enrollment processes communications can be carried out within the scope of the present disclosure using one or more of a plurality of such options, whether now known or future devised.

A non-exhaustive summary of currently know delivery systems comprises one or more of virtual meeting enrollment (for example, online video and/or phone meetings; virtual inbound enrollment (e.g., phone, live chat, text, etc.); online “self-service” enrollment; face-to-face enrollment; and/or group meetings.

As mentioned, each user's dashboard is unique to the user. In contrast, in the industry as it stood before the invention, the typical approach was to build company-wide communication materials, and then the business owner or human resources leaders are responsible for filtering and distributing information to each employee. Those prior systems fall short though, in that even the most sophisticated human resources leader is unable to deliver dynamic content that personalizes experiences for employees, for example, using preferred language, videos from managers, text messages that outline current coverage, emails that invite spouses into the process and call them by name, etc., all of which is achieved with the transformation technology disclosed herein.

In one embodiment, building an individual profile for each and every employee is a unique approach in the employee benefits industry because all profiles appear to be branded as the employer rather than a third party. If messages and experiences are branded as the benefits broker or insurance carrier, for instance, the information is oftentimes not trusted.

A key aspect of the present system is the ability to quickly build employee profiles with virtually infinite unique personal data points along with the business constraints that vary from company to company (e.g., branding logos, benefits offered, waiting periods, exclusions, locations, schedules, local management, languages, etc.), which enables the ability to track benefits enrollment at a never-before-seen depth, viz., the employee level. The disclosed system pioneers for the monitoring and improvement of the process of employee engagement in real time, while providing analytics back to the typically disconnected parties needed to execute enrollments—whether broker, carrier, business client, enrollment firm, or benefit counselor—all in a single system. The disclosed system moreover allows for these efficiencies across many companies that are assigned to varying brokers & carriers. Creating a similar system that allows for a 1-to-1 (for example, client to broker) would be much less effective, and arguably could not carry out the objects of the invention, without the added level of sophistication required to create and brand at the client and employee level in one master application.

In one embodiment, the data points, while potentially infinite in, number and character, further comprise or more of clicks on QR codes; text messages opened and/or read; email messages opened and or read; phone conversation summaries or recordings stored in data files; screen share conversations; live chat conversations; videos watched and the amount of time spent watching; mobile app interactions; URLs visited and ages click throughs by page; enrollment status; appointment and scheduling status; conversion rate of self-service enrollment systems; increases in participation; increased awareness amongst employees for health education; tracking visits to third party URL websites, and any other data points relevant to the building of a robust, well-populated library of profiles, all within a single system.

Building the personal profile of employees that include all of the necessary digital assets (e.g., URLs, digital brochures, QR codes, videos, mobile app interactions, text and/or email messages, etc.) would otherwise take hours and require management of a plethora of systems. Bringing all of these efficiencies together to simplify the process and reduce the time to build personal profiles is evident in the dashboard and related aspects of the instant disclosure.

The shared workspace that makes it simple for brokers, carriers, benefit administration systems, enrollment entities, and business clients to compile all of the necessary details to build a successful enrollment communication campaign. These unrelated parties typically have a disjointed process that leads to, among other problems, missed deadlines, misinformation, and duplication of information. Absent the system disclosed herein, here is otherwise no clear “source of truth” for users that brings together all of the elements required at the employee and client level together, prior to triggering a communication campaign.

The disclosed system simplifies the process by making it easy to drag and drop important files, upload videos and brochures, create branded content and URLs, upload and build online forms related to enrollment, and establish automated timelines and alerts. These features lead to more accurate enrollment information in the hands of employees and improves probability of meeting deadlines for business clients. Bringing otherwise unrelated parties together in a shared workspace to build enrollments significantly reduces the time, stress, and errors for all parties involved.

In another embodiment, the system further comprises a mobile app that allows users (e.g., brokers, human resources, carriers, benefit administrators, an enrollment entity, etc.) to construct customized mobile applications unique to each individual employee within a company. Prior to the system of the disclosure, it would take weeks or even months to curate such information for each client.

The system utilizes its transformational employee profile method and cross-references with our enrollment builder to provide an intuitive mobile app builder experience. Within minutes, a client branded app can be constructed with colors, logos, branding, messaging, and connections to third party vendors. In one embodiment, each action item within the app is customized so that each employee has a truly unique experience; also it prevents employees from seeing sensitive information concerning other employees within an organization.

While a great many app building options are already known, none combine the many features, access and interaction experiences of the presently disclosed system within the context of benefit enrollment. In one embodiment, one or more of the features are customizable when building an enrollment managing app, for example, an icon for a phone or desktop home screen, a logo and header color for in-app and desktop experience, a number of icons and icon images disposed throughout the mobile app pages; the colors of each icon title can be customized for client preferences; customized URL connections to each icon, where each icon is directed (note that internal and external links are both possibilities); the order and appearance of the icon display; and/or the language of the icon buttons.

Communicating to the employees within a company is typically a task left to the human resources department or other leadership within the organization. In regards to employee benefits, such approach is typically ineffective because it lacks relevant details, fails to engage employees based on their profile, and is delivered in the form of general announcements rather than targeted content.

The system enables employee-centric messaging which leads to higher conversion rates on calls to action. For example, social media advertising is able to target individuals based on their individual profiles whereas television commercials and radio ads only target a self-selecting sector of a population—social media advertising is proven to have a significantly higher advertising conversion rate.

The disclosed system therefore provides the employee benefits industry with the first ever employee-centric advertising medium. Targeted marketing (e.g., text, video, email, digital brochures, phone calls, etc.) that includes personalized information, delivered at optimal times and with optimized frequency therefore generate a higher conversion rate on the intended upon employee benefit objectives, such as participation in products, adoption of behavior, and compliance with wellness initiatives, etc.

The method disclosed herein enables brokers, carriers, business clients and enrollment entities to construct complex communication campaigns by guiding them through an intuitive front-end experience designed to extract the vital information necessary to build an effective communication campaign.

The system is the foundation for creating an automated communication campaign consisting of text, email, phone calls, and other forms of communication so that each employee within a company receives a truly unique series of messages, media, and frequency of communication.

Setting up these occurrences without the system would take hours if not days, even with experience and existing access to the available software tools on the market. The disclosed system and methods of use connect all of these otherwise disconnected solutions into one centralized dashboard, and has a customized layer of logic that simplifies the experience for the end user (broker, carrier, business client, etc.) so that a complex communication campaign can be created without any prior knowledge or background in these technologies.

While the system collects a lot of important data, that data is useless unless the user base understands how that data can impact their company or employees. For example, each of the user types defined above has a unique interest in how it impacts their respective profitability, time investment, and administrative experience. At the center of each interest is the employee from each business client.

Prior attempts to provide useful, real-time information to user types have failed. The inventive approach in the present disclosure is the ability to quickly build, populate, and make available to selected stakeholder in real time. The employee profiles are a nucleus that allows for build reporting and alerting automations that directly impact the behavior of employees and outcome of benefit enrollments.

A further method of using the system is also provided, the method comprising a great many possible steps and integrations of hardware, software, firmware and cloud ware to carry out required processes.

For example, key components used to practice the method comprise a service provider reporting server, for example, an online web service; an application programming interface (“API”); and a plurality of form API sheets comprising internal formulations.

In one example embodiment, the system disclosed herein utilizes existing technologies that may otherwise be disconnected for the purpose of meaningful and effective employee enrollment. In various embodiments, these systems include one or more of a plurality of such technologies, for example online calendar scheduling, automated email marketing, intuitive text messaging, video capture and distribution, QR code management, and engagement tracking. The system's unique processes bring all of these disconnected services into a single package along with the ability to display real-time results on the proprietary dashboard view described above.

In one embodiment, the service provider system essentially has two sides, viz., a client side and an administrative side.

On the client side, the process begins when a broker and/or client (who may be either an actual client or a broker agency) logs into a service provider-controlled website. Once logged in, they are able to upload individual employees or a batch of employees for the purpose of open enrollment and/or new hires with only minimal information in hand. Integration is maximized when the broker client uploads their data into the website, and then migrates the new hire data over to the service provider's server using API or another programming interface.

Assuming the administrative side agrees a record for the hire should be opened (and bearing in mind there may be many reasons for refusing to open record; for example, in the instance where a record already exists for the client, in which case it is possible to simply edit the original record rather than opening a new record), the service provider administrator authorizes the mutual release of the employee data to the relevant broker, broker client (which again, may be an agency), and/or enrollment agent data for comparison of the original hiring data to the broker, the broker client and the enrollment agent.

Assuming the parties agree to go forward, the compared data from the service provider server is returned to the client side via a processing interface; from there, the employee is assigned to an enrollment agent, who will assist the client in the process further. The employee is also entered into a database that allows mass messaging, which can include individualized content such as their specific medical options, identification of relevant supervisor(s), specific deadlines, etc.

The employee also has the ability to schedule a dedicated meeting, and the results of such meetings are updated in real-time on the system. Based on the outcome of the meetings, the employee, client, and broker all receive automated messages that help to bridge the gap to a resolution in an instant (compared to the current industry standard of days or even weeks). If the employee does not enroll, the broker is notified either periodically or upon request and receives a status update report regarding the new hire's lack of enrollment. on the other hand. the new hire does enroll, then the broker notifies the enrollment agent regarding the update in status.

Ordinarily skilled artisans will recognize that the system and methods described herein admit to several unexpected technical advantages; for example, using the methods disclosed herein the service provider is able to arrange candidate employment earlier in the process than would otherwise be possible, and, because the system continuously or regularly updates with new information during the process, greater safety for the hiring party is achieved while benefitting the new hire by facilitating core insurance benefit enrollments in a safe, secure, and integrated fashion that is carefully monitored and encouraged to the new hire.

In one embodiment, the enrollment process begins with an employee record being created. At this point, only the service provider can view and display the associated data. More or less simultaneously (though not necessarily so), the data is forwarded from the employee record using API to the system, which assigns employees to a marketing profile and enrollment agent based on client assignment and broker assignment.

Then, using API or another suitable means, the assignment is indicated to the enrollment agent, who updates associated data sheets, which then have internal sheet formulas applied and are sent back to the service provider system, where it can be confirmed, denied, amended, or simply stored until the next event occurs and the process is again updated.

From the user side, the process is made simpler, less complex, and easier to access and actually enroll in associated products. In one example embodiment, a progressive web app approach is used, wherein users clicking installed icons link to benefit guides specific to their situation so that the user does not have to select from a large plurality of possibly inapplicable products.

In another embodiment, the system automatically (or upon acceptance by the user) installs a desktop icon that is easily located and accessed by the user. In another embodiment, access to the system is created and maintained by downloading a favorite-type link into a user's web browser.

The desirability of front-end personalization and click through access to user-specific policies, pricing, etc., admits to an interface wherein a user's broker and the client can readily communicate regarding updates, policy offerings, and many other products in a simple, private operating environment, which in turn maximizes product client pairings with respect to broker's products.

In one example embodiment, the enrollment process described herein is available for both open enrollments and new hires. In one specific though non-limiting embodiment, “open Enrollment” is defined as an initial or annual start or renewal date that a company sets as its “policy year” for benefits.

For example, a given company might have a policy year that runs annually or another predefined benefit year interval. In another example, a given company may have an eligibility rule waiting period, e.g., employees are eligible the first day of the month following 60 days of full-time employment or another predefined date.

In yet another embodiment, open enrollment meetings are held in advance of the enrollment period so that clients can become more familiar with their purchasing options and more comfortable with the operating environment prior to enrollment.

In other embodiments, the term “new hires”is defined as the indefinite addition of newly hired employees throughout the year once open enrollment has concluded. In one example, employees eligible for benefits are enrolled throughout the year based on their defined benefit eligibility.

Turning now to another example embodiment, one object of the invention is to allow clients to access either a fixed or customizable dashboard that comprises both employee specific data and real-time data obtained from a plurality of sources.

In one embodiment, the employee specific data comprises bibliographic and other data relating to the client. In one example, the employee specific data comprises one or more the client's phone number, text address, email address, video(s) featuring the employee, benefit and/or insurance options, and/or any other subject relevant to the hiring and/or benefits or insurance enrollment process.

In another embodiment, the employee specific information is delivered to the employee dashboard interface by means of a service provider server, so that the resulting employee profiles can be quickly set up and populated, and files loaded to the dashboard interface, either in native format or as condensed for email, text, and/or other distribution means, whether currently known or future devised.

Clients such as employment agencies and the like also have access to the dashboard, so that records set up and populated by the service provider server are available. Such clients can be given authorizations and permissions to help streamline the process, for example, by adding new employees to the system and/or admitting to communications with the employee absent emails and texts and the like.

When direct employee communications are desired or required, an API or functionally equivalent programming interface creates a two-way communication path between the employee and the interface via a software platform and, via the programming interface texts, emails, calendar scheduling tools, etc., are made available and customizable for each employee.

For example, customized employee options might comprise the ability to have information delivered in native format, identify local supervisors for interaction, and/or creation of further customized specific employee or client data. In this manner, updates entered by the employee and others in the system quickly build up the employee file and dashboard records, employee specific documents such as insurance plans tailored to the employee's particular situation are uploaded and distributed, and all such updates are effectively updated in real time.

In a further embodiment, as the employee profile is built and expanded upon, an enrollment specialist or agent is assigned to the employee. The specialist or agent is available to the employee to help direct the employee toward appropriate benefit products, such as health care insurance, etc., and to provide relevant, targeted information, data, and materials to quickly and efficiently provide the employee with benefit enrollment assistance, copies of model policies videos explaining the benefit enrollment process, and so on.

The specialist or agent may (or may not) function under the control or direction of a broker, who reviews each client and makes recommendations entered through multi-level access to the server regarding likely appropriate benefit enrollment options and elections, especially during the new hire onboarding process, but also throughout the employee's employment as circumstances change and different benefit enrollment options become desirable or necessary. The capacity for real time reporting and notifications to specialists, agents and others admits to streamlined communications and file management heretofore unknown.

In a final example embodiment, the employee has access to the disclosed system via an app loaded on their cell phone or other device, whether presently known or future devised, that admits to maximum, on-the-go flexibility for both the employee and the service provider, thereby ensuring that benefit enrollment information and documentation, notifications, etc., are available to the employee throughout the process.

As is known, an app has an advantage over web sites in that they can be used to reach the system at any time, even when the employee is traveling or en route from one location to another. For example, by employing the disclosed architecture, an employee can be advised if they have missed an appointment, have a pending enrollment deadline, need to electronically sign documents, etc. Using API or another practical interface, the software platform can store, recall and deliver desired information to the employee app, send or receive texts, emails or other messages for uploading to the integrated server, etc.

Other advantages of app interaction with the system include the fact that there is no API download required at the user end, and that each of the buttons visible in the app are relevant to unique, individual employees without necessarily having to log in or otherwise interrogate the system.

Individual app buttons can be turned on and off throughout the year as new action windows open and close, and new products and current product offerings become available or are discontinued.

In further embodiments, the app environment is customizable as to one or more of color, presentation, branding, and so on, so that the user experience is truly unique and helpful to the employee.

Though the present invention is shown and described in detail above with respect to several exemplary embodiments, those of ordinary skill in the art will also appreciate that minor changes to the description, and various other modifications, omissions and additions may also be made without departing from either the spirit or scope thereof.

1. A computer assisted method for communicating updates regarding enrollment details and client registration in insurance products.
